(19) United States
(12) Patent Application Publication
(10) Pub. No.: US 2002/0195751 A1
(43) Pub. Date: Dec. 26, 2002

(54) Process of manufacturing bio-ceramic ball

(76) Inventors: Yong Jai Kim, Seoul (KR); Young Soo Lee, Seoul (KR); Hong Kim, Cheonan-Si (KR)

Correspondence Address: JACOBSON HOLMAN PLLC, 400 SEVENTH STREET N.W., SUITE 600, WASHINGTON, DC, 20004, US

(21) Appl. No.: 09/891,418

(22) Filed: Jun. 27, 2001

(30) Foreign Application Priority Data
Jun. 20, 2001 (KR) 2001-34978

(51) Int. Cl. C04B 35/622

(52) U.S. Cl. 264/669; 264/666

(57) ABSTRACT

Provided is a process of manufacturing a bio-ceramic ball, the process including the steps of pulverizing a raw material containing 35% of coal sludge remaining after ion milling, 15% of a ceramic material consisting of quartz, 5% of peridot having evening emerald components, 4% of emerald which is a green precious stone and 41% of approximately 40 sorts of other minerals, including elvan, into less than or equal to 700 mesh, mixing the pulverized raw material with extracts containing 30% of pine leaves, 20% of mugwort, 15% of motherwort, 10% of Polygoni multiflori Radix and 25% of approximately 30 sorts of other plant medicines, and agitating in a tank, primarily heating the mixed and agitated materials in a crucible at a temperature of approximately 1300° C. for about 24 hours, naturally cooling the heated mixture until the mixture becomes completely cold, placing the resultant material into glazing extracts containing 40% of pine leaves, 30% of mugwort, 20% of motherwort and 10% of approximately 30 sorts of other plant medicines, and secondarily heating the glazed material in a crucible at a high temperature of approximately 1800° C. for about 48 hour. Since the durability of the bio-ceramic balls is remarkably improved, the bio-ceramic balls can be used semi-permanently. Further, the quality of water or the fuel efficiency of an automobile, can be improved by placing the bio-ceramic balls in a water tank or fuel tank. Also, when a user drinks water purified by the bio-ceramic balls, effects of promoting user's health and treating several diseases can be exhibited.

### BACKGROUND OF THE INVENTION

1. Field of the Invention

The present invention relates to a process of manufacturing a bio-ceramic product having various beneficial functions, and more particularly, to a process of manufacturing a bio-ceramic ball which can emit a large amount of negative ions and far infrared rays that are beneficial to the human body, to promote user's health, and which can be advantageously used for improving the fuel efficiency of vehicles or purifying waste water.

2. Description of the Related Art

In general, as people get to be concerned about their health, various researches into negative ions and far infrared rays that are helpful to the human body are being carried out and a various kinds of products using the same are being produced. In particular, ceramic products having bio-compatible components (to be called bio-ceramic products) are being produced in various types. The bio-ceramic products emit negative ions or far infrared rays that are helpful to the human body.

In other words, negative ions emitted from the bio-ceramic products serve just like forest or fresh air to people. Applying negative ions to the human body is effective in controlling the flow of energy throughout the human body. Also, people's movement and autonomic nerve operation, can be adjusted by strengthening biological effects, vitality and immunizing capability, which presumably originate from negative ions. In such manners, negative ions can promote various medical, physiological effects.

Also, negative ions are largely related to trees, the nature of the soil or the quality of air as well as human's spirit energy. The negative ions are not only inhaled by respiration through lungs but also are permeated into the body through the skin.

Far infrared rays, that is, another component emitted from the bio-ceramic products, are the purest and strongest heat rays of solar radiations. The far infrared rays which are colorless, invisible electromagnetic waves, are natural vitalizing rays that are useful to the human body, exhibiting various medical effects including elevation of the temperature of a hypoderm skin layer by directly transferring emissive heat to deep layers of the human body, dilation of blood vessels, promotion of blood circulation, elimination of waste matter from the system, promotion of metabolism and so on.

The bio ceramic material can be applied to food containers, construction materials and various kinds of health products to promote user's health, and can be applied to various products such as filters for purifying water or air cleaners.

However, the conventional bio-ceramic products have several disadvantages, such as a poor efficiency of emitting far infrared rays or a weak energy. Also, the conventional bio-ceramic products are fragile, that is, poor in durability. Further, since the negative ions or far infrared rays emitted from the bio-ceramic products are exhausted quickly, the bio-ceramic products cannot remain unchanged in their efficacy.

### SUMMARY OF THE INVENTION

Accordingly, the present invention is derived to resolve the above disadvantages of conventional bio-ceramic products and it is an object of the present invention to provide a bio-ceramic ball from which a large quantity of negative ions and far infrared rays that are helpful to the human body to promote user's health, and which can be used semi-permanently while improving durability.

To accomplish the above object of the present invention, there is provided a process of manufacturing a bio-ceramic ball, the process including the steps of pulverizing a raw material containing 35% of coal sludge remaining after ion milling, 15% of a ceramic material consisting of quartz, 5% of peridot having evening emerald components, 4% of emerald which is a green precious stone and 41% of approximately 40 sorts of other minerals, including elvan, into less than or equal to 700 mesh, mixing the pulverized raw material with extracts containing 30% of pine leaves, 20% of mugwort, 15% of motherwort, 10% of Polygoni multiflori Radix and 25% of approximately 30 sorts of other plant medicines, and agitating in a tank, primarily heating the mixed and agitated materials in a crucible at a temperature of approximately 1300° C. for about 24 hours, naturally cooling the heated mixture until the mixture becomes completely cold, placing the resultant material into glazing extracts containing 40% of pine leaves, 30% of mugwort, 20% of motherwort and 10% of approximately 30 sorts of other plant medicines; and seconadarily heat the glazed material in a crucible at a high temperature of approximately 1800° C. for about 48 hour.

In other words, the bio-ceramic ball manufactured by the above-described method is constructed such that it can simultaneously emit negative ions and far infrared rays. Also, when the bio-ceramic ball is installed on a specific-purpose tank, for example, a water tank or fuel tank, it can purify water or promote activation of automobile fuel.

Therefore, according to the bio-ceramic ball of the present invention, a greater amount of negative ions and far infrared rays are emitted, fulfilling consumers' satisfaction. Also, the durability of the bio-ceramic ball can be greatly improved, so that the bio-ceramic ball can be used semi-permanently. When the bio-ceramic ball is installed on a water tank or fuel tank, it can greatly improve the quality of water in the water tank or the fuel efficiency of an automobile. Further, a user who drinks water purified by the bio-ceramic ball can experience health promotion and various medical, physiological effects.

### BRIEF DESCRIPTION OF THE DRAWINGS

The above object and advantages of the present invention will become more apparent by describing in detail a preferred embodiment thereof with reference to the attached drawings in which:

FIG. 1 is a flow diagram showing the process of manufacturing a bio-ceramic ball according to the present invention; and

FIG. 2 is a perspective view of a state in which the bio-ceramic ball according to the present invention is in use.

### DESCRIPTION OF THE PREFERRED EMBODIMENT

A preferred embodiment of the present invention will now be described in detail with reference to the accompanying drawings.

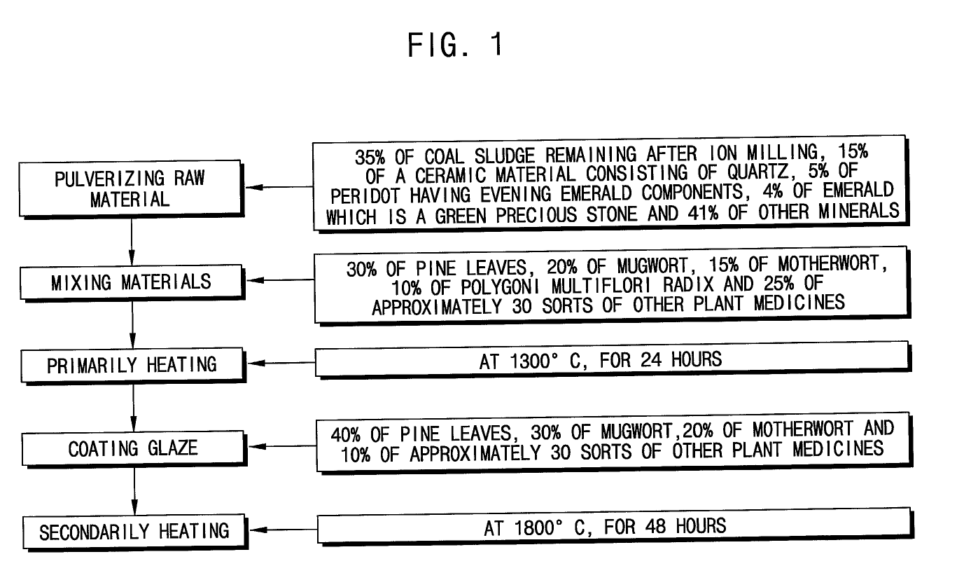

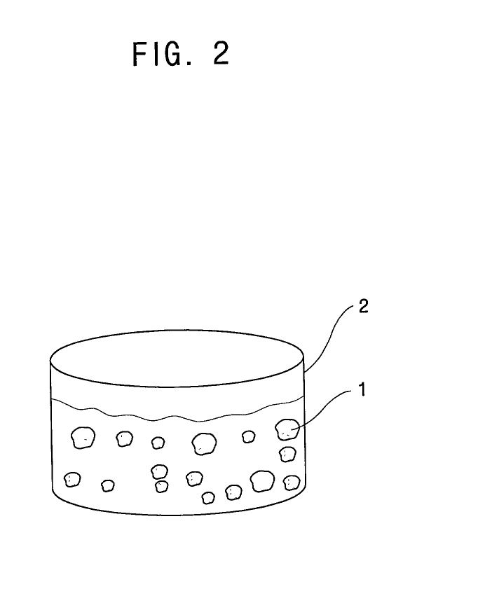

FIG. 1 is a flow diagram showing the process of manufacturing a bio-ceramic ball according to the present invention, and FIG. 2 is a perspective view of a state in which the bio-ceramic ball according to the present invention is in use.

A process of manufacturing a bio-ceramic ball 1 according to the present invention, which emits both negative ions and far infrared rays, will now be described with reference to FIGS. 1 and 2. A raw material containing 35% of coal sludge remaining after ion milling, 15% of a ceramic material consisting of quartz, 5% of peridot having evening emerald components, 4% of emerald which is a green precious stone and 41% of approximately 40 sorts of other minerals, including elvan, is pulverized into less than or equal to 700 mesh. The pulverized raw material is mixed with extracts containing 30% of pine leaves, 20% of mugwort, 15% of motherwort, 10% of Polygoni multiflori Radix and 25% of approximately 30 sorts of other plant medicines, and agitated in a tank. Unless otherwise noted, all the percentages are by weight. The mixed and agitated materials are heated in a crucible at a temperature of approximately 1300° C. for about 24 hours and then naturally cooled until the mixture becomes completely cold. Then, the resultant material is placed into glazing extracts containing 40% of pine leaves, 30% of mugwort, 20% of motherwort and 10% of approximately 30 sorts of other plant medicines. The glazed material is again thermally treated in a crucible at a high temperature of approximately 1800° C. for about 48 hours.

The bio-ceramic ball 1 manufactured by the above-described process may take various sizes and shapes according to usage. In addition to the shape of a ball, a pipe-shaped bio-ceramic product can be manufactured, if necessary, so that water flowing therethrough can be purified.

Here, the thus-manufactured bio-ceramic ball 1 configured to emit an abundant amount of negative ions and far infrared rays is characterized in that 44 sorts of minerals and 33 plant medicines capable of emitting negative ions and far infrared rays are mixed in an appropriate ratio and thermally treated at a high temperature.

The process of manufacturing the bio-ceramic ball 1 will now be described in detail by sequential steps.

Pulverizing

A raw material containing 35% of coal sludge remaining after ion milling, 15% of a ceramic material consisting of quartz, 5% of peridot having evening emerald components, 4% of emerald which is a green precious stone and 41% of approximately 40 sorts of other minerals, including elvan, is pulverized into less than or equal to 700 mesh.

Mixing

The pulverized raw material is mixed with extracts containing 30% of pine leaves, 20% of mugwort, 15% of motherwort, 10% of Polygoni multiflori Radix and 25% of approximately 30 sorts of other plant medicines, and agitated in a tank.

Primarily Heating

The mixed and agitated materials are heated in a crucible at a temperature of approximately 1300° C. for about 24 hours.

Glazing

The heated mixture is naturally cooled until the mixture becomes completely cold, and then the resultant material is placed into glazing extracts containing 40% of pine leaves, 30% of mugwort, 20% of motherwort and 10% of approximately 30 sorts of other plant medicines.

Secondarily Heating

The glazed material is again thermally treated in a crucible at a high temperature of approximately 1800° C. for about 48 hours.

The state in which the bio-ceramic ball 1 manufactured in the above-described steps is in actual use will now be described with reference to FIG. 2. As shown in FIG. 2, a plurality of bio-ceramic balls 1 are placed into a tank 2 such as a water tank, fuel tank or sewage tank. The water or fuel contained in the tank 2 is purified or activated using negative ions or far infrared rays emitted from the bio-ceramic balls 1.

Here, the bio-ceramic balls 1 can be variably tailored according to usage. For example, the first class bio-ceramic balls can be used for medical purposes, and the second class high quality bio-ceramic balls can be used for water purifying purposes. Also, the third class bio-ceramic balls can be used for air cleaning purposes, the fourth class bio-ceramic balls can be used for fuel saving purposes, and the fifth class bio-ceramic balls can be used for sewage treatment purposes.

Now, major effects of the bio-ceramic ball 1 manufactured by the above-described manner will be described. In other words, ordinary water can be converted into better quality water of less than or equal to 120 in the degree of transition. Also, the fuel contained in an automobile fuel tank can be activated, thereby improving the fuel efficiency and reducing exhaustion of pollutants. Further, various diseases such as visceral disease, e.g., constipation, atopic dermatitis or diabetes can be treated by drinking water purified by the bio-ceramic ball 1.

As described above, in the process of manufacturing bio-ceramic balls according to the present invention, the amount of negative ions and far infrared rays emitted from the bio-ceramic balls is greatly increased compared to conventional bio-ceramic products, thereby fulfilling customers' satisfaction. Also, the durability of the bio-ceramic balls is remarkably improved, so that the bio-ceramic balls can be used semi-permanently. Further, the quality of water or the fuel efficiency of an automobile, can be improved by placing the bio-ceramic balls in a water tank or fuel tank. Also, when a user drinks water purified by the bio-ceramic balls, effects of promoting user's health and treating several diseases can be exhibited.

What is claimed is:

1. A process of manufacturing a bio-ceramic ball, comprising the steps of:
pulverizing a raw material containing 35% of coal sludge remaining after ion milling, 15% of a ceramic material consisting of quartz, 5% of peridot having evening emerald components, 4% of emerald which is a green precious stone and 41% of approximately 40 sorts of other minerals, including elvan, into less than or equal to 700 mesh;
mixing the pulverized raw material with extracts containing 30% of pine leaves, 20% of mugwort, 15% of motherwort, 10% of Polygoni multiflori Radix and 25% of approximately 30 sorts of other plant medicines, and agitating in a tank;
primarily heating the mixed and agitated materials in a crucible at a temperature of approximately 1300° C. for about 24 hours;
naturally cooling the heated mixture until the mixture becomes completely cold, and placing the resultant material into glazing extracts containing 40% of pine leaves, 30% of mugwort, 20% of motherwort and 10% of approximately 30 sorts of other plant medicines; and
secondarily treating the glazed material in a crucible at a high temperature of approximately 1800° C. for about 48 hour.
